(19) United States
(12) Patent Application Publication
(10) Pub. No.: US 2021/0045475 A1
(43) Pub. Date: Feb. 18, 2021

(54) VAPOR-PERMEABLE INSERT FOR AN ITEM OF CLOTHING AND FOOTWEAR, ITEM OF CLOTHING AND FOOTWEAR WITH SUCH INSERT

(71) Applicant: GEOX S.p.A., Montebelluna (IT)

(72) Inventors: Mario POLEGATO MORETTI, Crocetta Del Montello (IT); Marco BRUNO, Ivrea (IT); Michele RAMPIN, Borgoricco (IT); Christian MARCON, Povegliano (IT)

(73) Assignee: GEOX S.p.A., Montebelluna (IT)

(21) Appl. No.: 16/965,491

(22) PCT Filed: Feb. 4, 2019
(86) PCT No.: PCT/IB2019/050877

§ 371 Date: Jul. 28, 2020

(30) Foreign Application Priority Data
Feb. 6, 2018 (IT) 102018000002423

(51) Int. Cl. A41D 31/02; A41D 27/28; A41D 3/00; A43B 7/08; B32B 3/26; B32B 27/40

(52) U.S. Cl. CPC A41D 31/02; A41D 27/28; A41D 3/00; B32B 27/08; B32B 3/266; B32B 27/40; A43B 7/08

(57) ABSTRACT

A vapor-permeable insert for an item of clothing and footwear, including at least one first layer provided with at least one blind opening, and at least one second layer, which has at least one temporarily deformable portion, which includes a material that is sensitive to humidity and/or temperature variations.

The present invention relates to a vapor-permeable insert for an item of clothing and footwear.

The present invention also relates to an item of clothing and to footwear provided with such insert.

Items of clothing are currently known which shelter the user from atmospheric agents and are made of materials adapted to provide a sufficient level of thermal insulation.

The aim of these items of clothing is to maintain a microclimate around the body of the user that is capable of giving him an adequate level of comfort, preventing the body from cooling excessively.

Items of clothing are also known which provide in addition temperature control systems.

Among these there are, for example, openings on the outermost layer in order to avoid the excessive increase of the temperature of the microclimate and/or facilitate the expulsion toward the outside environment of sweat in the vapor phase.

U.S. Pat. No. 9,060,551 B2 contains the teachings for providing an item of clothing provided with dynamic openings on the internal and/or external fabric which may, as a consequence of a stimulus such as a temperature or humidity variation, open in order to increase permeability to air or close to prevent the entry of rain inside the item.

These dynamic openings mentioned above, however, increase the complexity in the process for the manufacture of the item, limiting the freedom of choice of materials and conditioning aesthetic choices.

Furthermore, if the openings are located on the outer layer of the item, in rainy conditions they close, limiting therefore the outflow of sweat in the vapor phase.

The teachings for providing an item of clothing provided with an auxetic structure which is extended on an x-y plane, capable of transitioning from a first thickness in a direction z, which is perpendicular to the x-y plane, to a second thickness in response to a stimulus, are also known from U.S. Pat. No. 9,192,198 B2.

The expression “auxetic structure” refers to a structure which, when elongated, increases its thickness in the direction at right angles to the one in which the stress is applied.

The above-cited structure is able to modify the thermal insulation capacity of the item of clothing by varying its own thickness and therefore the volume of air contained therein.

However, such a structure is characterized by a substantially invariable permeability to vapor.

Furthermore, when an auxetic structure is used as padding for an item of clothing, the size of its thickness variation is low or in any case limited, since it is constrained by the tension of the fabrics that contain said padding.

This drawback in practice limits the temperature range within which the padding is capable of providing an adequate level of thermal insulation.

U.S. Pat. No. 7,347,774 B2 contains the teachings for providing an item of clothing that comprises regions of fabric that modify their structure upon stimuli such as contact with water or temperature variations.

The above-cited regions are constituted by a structure that has a lower layer and an upper layer.

The upper layer comprises a material that modifies its dimensions upon contact with water or temperature variations and is provided with incisions.

These incisions form flaps which, upon the mentioned stimuli, curl up or contract, producing ventilation openings at the incisions.

However, these incisions are limited to the upper layer and accordingly ventilation is greatly affected by the presence of the lower layer without incisions.

If the lower layer has, for example, a high thermal insulation value, it might therefore reduce in a non-negligible manner the benefit provided by ventilation.

Moreover, items of clothing are known which comprise traditional insulating structures composed for example of a polyester or polypropylene wadding and have through openings which increase their breathability.

Among these there is, for example, the product marketed under the trademark Ventrix of the company The North Face Apparel Corp.

However, the insulating capacity or thermal insulation of the insulating structure and of the items of clothing that contain it decreases drastically at the through openings.

Therefore, in order to maintain adequate thermal insulation, it is necessary to increase the thickness of the insulating structure.

This, however, entails some drawbacks, linked to an increase in the weight of the insulating structure and of the item and to a stiffening of said item.

Furthermore, this determines greater difficulty in making the item of clothing, due to the greater space occupation of the insulating structure.

Items of clothing are also known which are provided with insulating structures which comprise a layer of polyester or polypropylene wadding on which a polymeric layer is superimposed which increases and improves the thermal insulation of the structure.

However, the polymeric layer limits the breathability of these insulating structures and accordingly also of the item of clothing that contains them.

The aim of the present invention is to provide a vapor-permeable insert for an item of clothing and footwear, an item of clothing and footwear with such insert, capable of improving the background art in one or more of the aspects indicated above.

Within this aim, an object of the invention is to provide a vapor-permeable insert for an item of clothing and footwear, an item of clothing and footwear with such insert, capable of varying their thermal insulation capacity as the temperature varies.

Another object of the invention is to provide a vapor-permeable insert for an item of clothing and footwear, an item of clothing and footwear with such insert, capable of varying its permeability to sweat in the vapor phase as the humidity varies.

Another object of the invention is to overcome the drawbacks of the known art in an alternative way compared to practicable know solutions.

Another object of the invention is to provide a vapor-permeable insert for an item of clothing and footwear that is highly reliable, is relatively simple to provide and at competitive costs.

This aim, as well as these and others which will become better apparent hereinafter are achieved by a vapor-permeable insert for an item of clothing and footwear, characterized in that it comprises at least one first layer which has at least one blind opening, and at least one second layer, which has at least one temporarily deformable portion, comprising a material that is sensitive to humidity and/or temperature variation.

Further characteristics and advantages of the invention will become better apparent from the description of some preferred but not exclusive embodiments of the vapor-permeable insert for an item of clothing and footwear according to the invention, illustrated by way of nonlimiting example in the accompanying drawings, wherein:

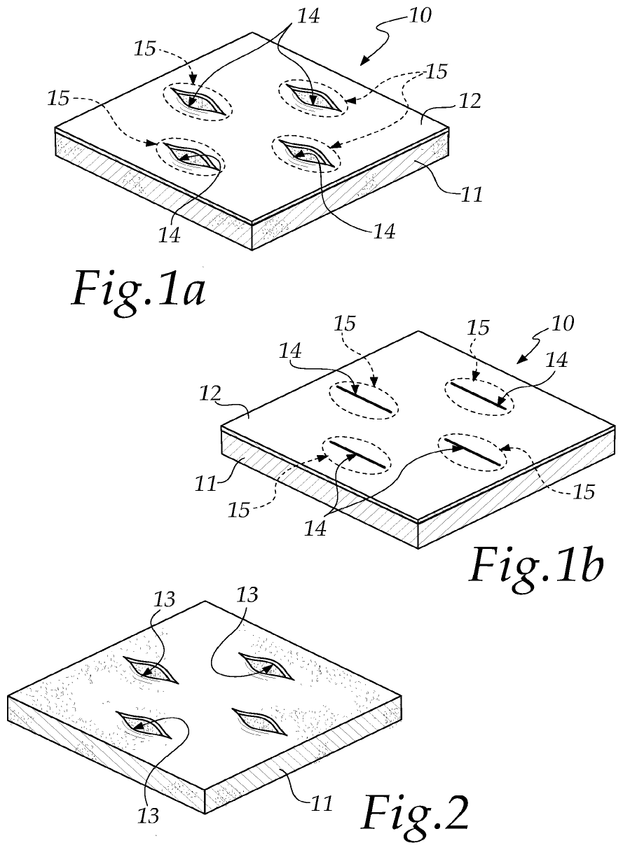

FIGS. 1a and 1b are views of a vapor-permeable insert for an item of clothing and footwear according to the invention in the two operating configurations;

FIG. 2 is a view of a detail of the vapor-permeable insert according to the invention, in the configuration of FIG. 1a;

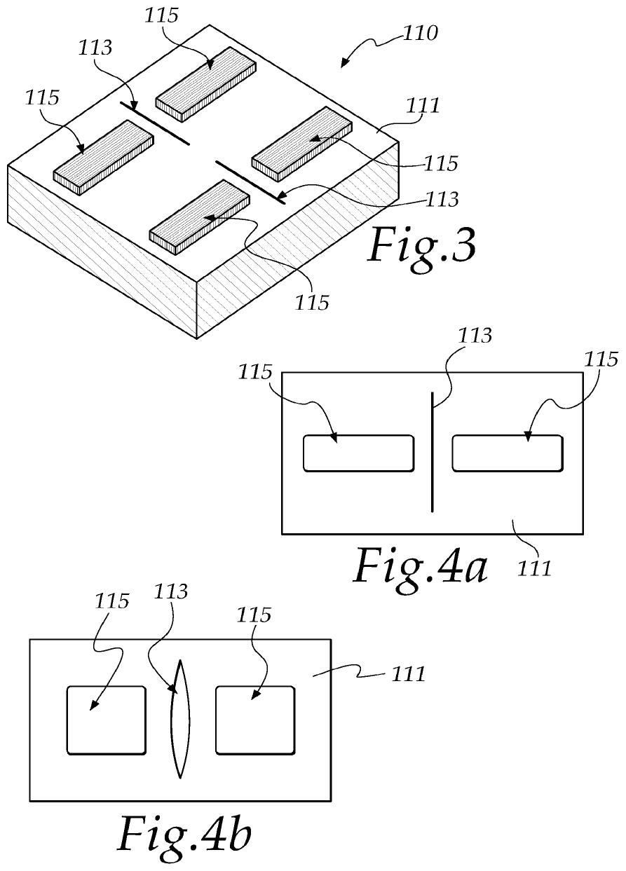

FIG. 3 is a view of a vapor-permeable insert for an item of clothing and footwear according to the invention, in a second embodiment;

FIGS. 4a and 4b are views of a detail of the insert of FIG. 3 in the two operating configurations;

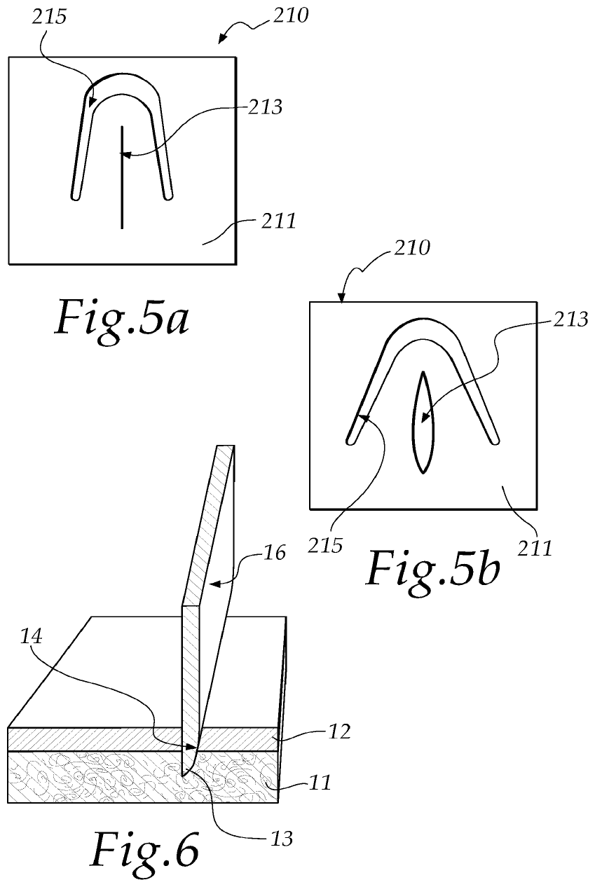

FIGS. 5a and 5b are views of a vapor-permeable insert for an item of clothing and footwear according to the invention in a third embodiment, in the two operating configurations;

FIG. 6 is a view of a method for providing a detail of the insert according to the invention;

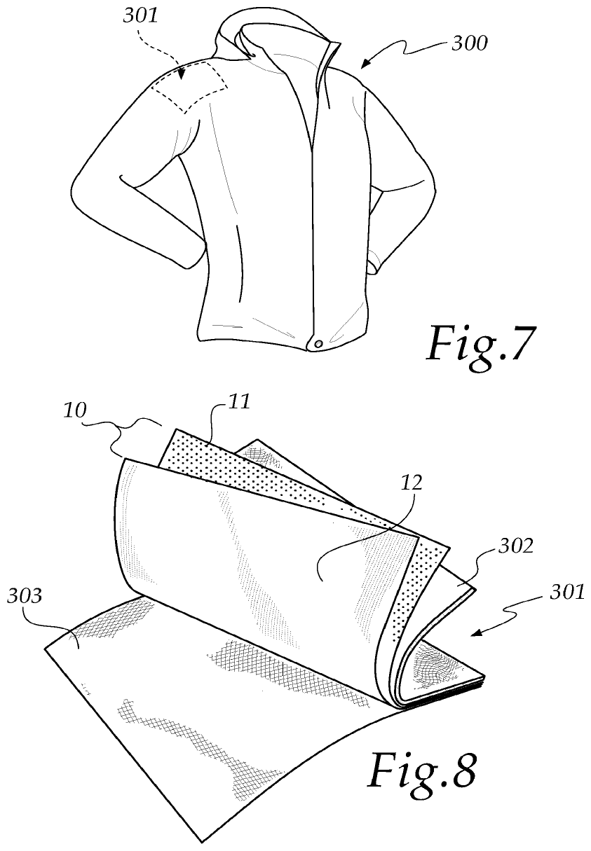

FIG. 7 is a view of an item of clothing with an insert according to the invention;

FIG. 8 is a view of a detail of the item of clothing of FIG. 7;

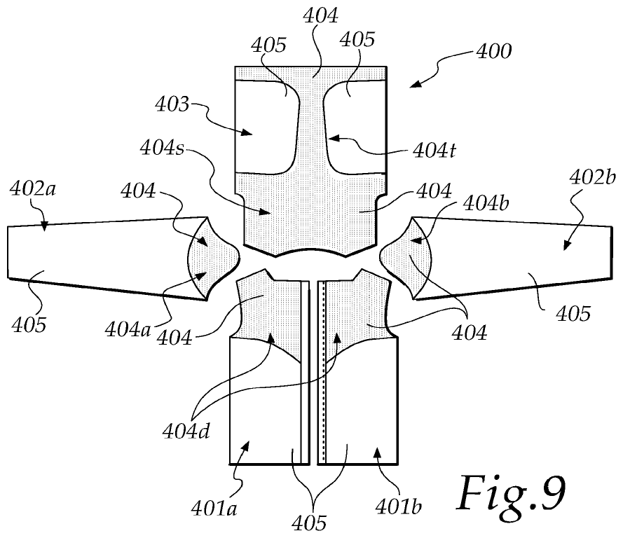

FIG. 9 is a disassembled view of an item of clothing with an insert according to the invention in a different embodiment;

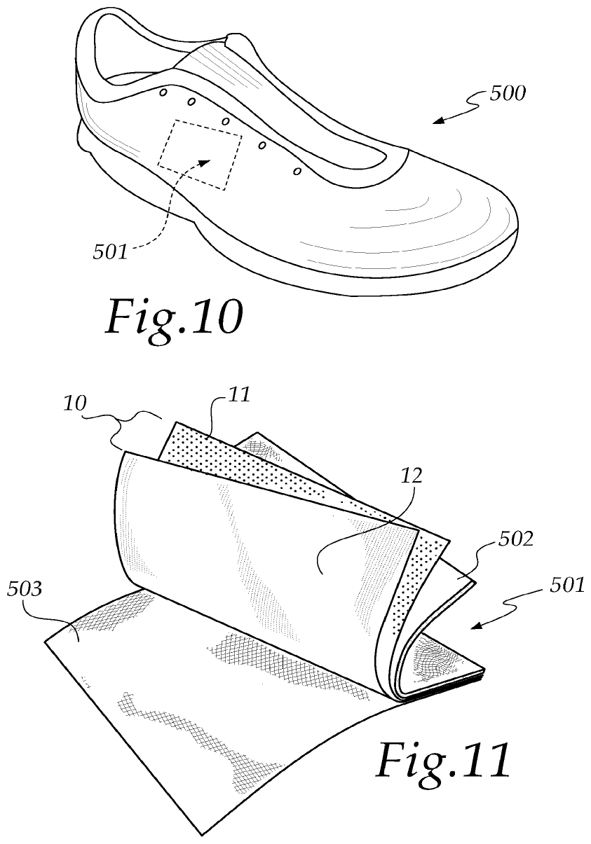

FIG. 10 is a view of footwear with an insert according to the invention;

FIG. 11 is a view of a detail of footwear of FIG. 10.

With reference to FIGS. 1a and 1b, an insert according to the invention is designated generally by the reference numeral 10.

Such insert 10 comprises a first layer 11 and a second layer 12 which faces the first layer 11.

These two layers are distributed uniformly and have facing surfaces with comparable dimensions.

The first layer 11 is made of insulating material, such as for example a synthetic wadding of a known type, or the like, and is provided with at least one blind opening 13, starting from the surface that faces the second layer 12, as shown in FIG. 2.

The second layer 12 comprises at least one temporarily deformable portion 15, proximate and/or at at least one opening 13 of the first layer 11.

The expression “temporarily deformable” means that the portion is deformed if subjected to given climate conditions of the environment in which it is placed, which in the case of the invention are temperature and/or humidity increases, as described hereinafter, to return to the initial shape once the initial climate conditions have been reestablished.

Within the portion 15, the second layer 12 is provided with at least one through cut 14.

The at least one cut 14 is at least partially superimposed on the at least one opening 13.

The second layer 12 is made, at least in each portion 15, of a material that is sensitive to temperature and/or humidity variations, preferably a polymeric material with shape memory (Shape Memory Polymer or SMP).

Polymeric materials with shape memory are capable of storing one or more shapes and of shifting from a first shape to a second shape upon the application of a stimulus.

In the case of the present invention, this stimulus is constituted by a temperature or humidity variation.

A first shape is given to the polymeric material during a processing step.

A second shape and optionally additional shapes are instead given to the material during one or more programming steps, during which the polymer is deformed.

The recovery step is the step during which the material recovers the first shape which preceded deformation.

This polymeric material with shape memory may shift repeatedly from a first shape to a second shape or to one of the additional shapes without there being a significant deterioration of the geometry of such shapes.

Considering thermoplastic polymers, in general, if one applies a force for a short time to a sample of thermoplastic polymer above the glass transition temperature, the sample elastically recovers its original shape as soon as the application of the force ceases. If instead the application is maintained for a longer time, an irreversible deformation occurs due to the mutual sliding of the polymeric chains.

In presence of cross-linking points, instead, the sliding of the polymeric chains is hindered.

In order to obtain cross-linking points it is necessary to have a phase separation within the sample with flexible domains that constitute the thermally reversible phase, or soft phase, and rigid domains that form the fixed phase, or rigid phase.

The fixed phase has a higher melting point than the thermally reversible phase.

The transition temperature linked to rigid domains i.e. to the fixed phase, normally coincides with the glass transition temperature of the fixed phase and is the highest allowed: if the temperature of the polymer is higher than this transition temperature, the polymer melts.

The transition temperature linked to rigid domains is responsible for the definition of the first shape.

During the processing step, the polymeric material is heated and deformed above this transition temperature, in order to give it a first shape that is stable at a temperature that is lower than said transition temperature of the fixed phase.

Then a programming step is performed in which the material is imparted a second shape, which is stable at a temperature that is lower than the transition temperature of the flexible domains, and is linked to the soft phase.

The programming step occurs at a temperature comprised between the transition temperature of the flexible domains and the transition temperature of the rigid domains, followed by quick cooling below the transition temperature linked to the soft phase.

The transition temperature of the flexible domains usually coincides with the glass transition temperature of the soft phase.

Quick cooling causes the crystallization of the flexible domains and this prevents shape recovery and entails an accumulation of internal tension in the second shape.

The recovery step provides for the heating of the material, in its second shape, to the temperature comprised between the transition temperature of the flexible domains and the transition temperature of the rigid domains, which brings the polymer to its first shape.

The heating of the material above the transition temperature of the soft phase releases the accumulated internal tension, facilitating the repositioning of the polymeric chains in their initial shape.

For these reasons, recovery of the first shape imparted previously, accompanied by a sudden reduction in elastic modulus, is observed.

As long as the material remains below the transition temperature of the flexible domains, thermodynamic barriers persist which prevent the polymeric chains from returning to the initial state with higher entropy.

In the initial state these domains were at a temperature comprised between the transition temperature of the flexible domains and the transition temperature of the rigid domains.

The transition temperature of the flexible domains acts as a molecular switch, allowing the definition of the second shape.

The thermally reversible phase acts as a physical cross-linking agent and this effect is inversely proportional to the temperature.

Above the transition temperature of the soft phase, any cross-linking property of the thermally reversible phase ceases to exist and the accumulated tension allows the recovery of the first shape.

Considering polyurethanes, their behavior as shape memory polymers is due to the presence of a soft phase, constituted by a polyol, and a rigid phase, constituted by a diisocyanate coupled with a chain extender.

In particular, in polyurethanes exposure to humidity causes a lowering of the glass transition temperature.

This phenomenon may be used to make the polymeric shape memory material pass from a second shape to a first shape, which generally correspond to a temperature respectively below or above the transition temperature of the soft domains.

Such a shape variation may be provided simply by varying the humidity to which the polymeric material is subjected, without there being a significant temperature variation.

As a consequence of what has been stated, as the humidity increases at a substantially constant temperature, polyurethanes tend to soften.

Increasing the humidity while leaving the temperature substantially unchanged may therefore determine the same result that would occur by increasing the temperature.

Such a shape memory polymer has a behavior that is sensitive to humidity variations.

The values of the transition temperature of the fixed phase and of the transition temperature of the soft phase may be easily established theoretically and validated by means of thermomechanical tests.

In general, the glass transition temperature varies from −30° C. to 260° C.

There are also polymers with triple shape memory, which comprise two second shapes and a first shape.

The transition through the various shapes occurs by means of gradual temperature increases. The ones obtained by superimposing two layers of distinct shape memory polymers, each characterized by a different glass transition of its soft phase, or thermally reversible phase, are of particular interest for the present invention.

The second layer 12 is substantially coupled to the first layer 11 at least at each deformable portion 15, for example by adhesion, in a neighborhood which comprises the at least one opening 13 of the first layer 11.

Adhesion may be achieved for example by means of heat-activated glue spots or by grip of the polymeric material on the first layer 11.

The operation of the insert is the one shown in FIGS. 1a and 1b and is as follows.

Temperature and/or humidity variations cause variations in the shape of the deformable portion 15 in at least one spatial dimension. Since the at least one deformable portion 15 is coupled to the first layer 11, these shape variations cause variations of the width of the at least one cut 14, thus producing a greater or smaller permeability to air and sweat in the vapor phase of the structure of the insert 10.

FIG. 1a is a view of the insert 10 with the deformable portions 15 of the second layer 12 in the open configuration of the cuts 14 (first shape).

The expression “opening of the cuts 14” means that the opposite flaps of the second layer 12, which form them, are visibly spaced.

FIG. 1b is instead a view of the insert 10 with the deformable portions 15 of the second layer 12 in a substantially closed configuration of the cuts 14 (second shape).

The expression “closure of the cuts 14” means that the opposite flaps of the second layer 12 that form them are visibly close and/or substantially coincide.

FIG. 2 is a view of only the first layer 11 in the configuration of the insert 10 shown in FIG. 1a.

The transition from an open condition to a substantial closure condition and vice versa of the at least one cut 14 is produced by means of a movement of the flaps of the one or more cuts 14, which is substantially replicated by the at least one opening 13.

This depends on the fact that the at least one deformable portion 15 is coupled to the first layer 11.

The at least one cut 14 may have different geometric shapes according to the requirements, and for example may be shaped like a cross and/or a letter C and/or a letter L and/or a letter T and/or a crescent and/or combinations thereof.

The at least one opening 13 partially penetrates the first layer 11 and may have substantially the same geometric shape as the at least one corresponding cut 14.

Preferably, but without limitation, the at least one opening 13 has a depth comprised between 0.1 and 0.8 mm.

The process for providing the insert 10 provides for the application of the second layer 12 onto the first layer 11 and subsequently the provision of the at least one cut 14 and of the at least one opening 13, for example by using a laser cut or a hot air knife.

One possible process for the provision of the openings is shown schematically in FIG. 6, with the laser beam designated by the reference numeral 16.

The laser beam 16 passes completely through the thickness of the second layer 12 and penetrates only partially the first layer 11.

Appropriate adjustments of the power of the laser beam 16 allow to establish the penetration depth in the first layer 11.

The at least one portion 15 used in the process has already stored the first shape in the processing step and the second shape in the programming step, and is at a temperature that is lower than the transition temperature of the flexible domains. In particular, the quick cooling that has occurred during the programming step has crystallized the soft phase contained in the polymeric material, trapping elastic energy, and prevents the at least one cut 14 from opening. The at least one cut 14 opens when the deformable portion 15 is at a temperature that is higher than the transition temperature of the flexible domains, releasing the elastic energy.

FIG. 3 shows a second embodiment of the insert, designated generally by the reference numeral 110.

In this second embodiment, the insert 110 is provided with a first layer 111 made of insulating material which comprises at least one blind opening 113.

A second layer faces said first layer 111 and is constituted by a plurality of temporary deformable portions 115, associated with the first layer 111, proximate to the at least one opening 113.

These portions 115 are strips made of polymeric material that is sensitive to the temperature or humidity variations and preferably an SMP.

This polymeric material tends to soften as the temperature of the environment in which it is placed increases or as the absorbed humidity increases.

FIG. 4a is a plan view of a substantially closed configuration of the at least one opening 113.

FIG. 4b is a plan view of an open configuration of the at least one opening 113.

As is evident from FIGS. 4a and 4b, the temporarily deformable portions 115 vary their shape as a consequence of variations in temperature or relative humidity, and by being associated with the first layer 111 they produce the spacing or approach of the flaps of the at least one opening 113.

In a condition of substantial closure of the at least one opening 113, the polymeric material has such a hardness as to maintain a second elongated shape, which is imposed during the step of manufacturing the plurality of temporarily deformable portions 115, overcoming the elastic force that would instead tend to shorten the strips.

As the temperature and/or humidity of the surrounding environment increases, instead, said polymeric material softens and therefore the accumulated elastic energy is released, bringing the plurality of temporarily deformable portions 115 to a first less elongated shape. The contraction of the plurality of temporarily deformable portions 115 produces the opening of the at least one opening 113.

FIGS. 5a and 5b show the insert according to the invention in a third embodiment.

In this embodiment, the insert is designated generally by the reference numeral 210.

The insert 210 is provided with a first layer 211 made of insulating material which comprises at least one blind opening 213.

A second layer, constituted by a plurality of temporarily deformable portions 215, associated with the first layer 211, proximate to the at least one opening 213, faces said first layer 211.

In this embodiment, the portions 215 are U-shaped strips, made of polymeric material that is sensitive to temperature and/or humidity variations and preferably an SMP.

FIG. 5a is a plan view of a substantially closed configuration of the at least one opening 213 which corresponds to a second shape of the deformable portion 215.

FIG. 5b is a plan view of an open configuration of the at least one opening 213 which corresponds to the first shape of the deformable portion 215.

FIGS. 5a and 5b represent the effect caused by opposite stimuli on the at least one portion 215.

According to a method for the provision of such an insert 110, 210, the at least one portion 115, 215 has already stored the first shape in the processing step and the second shape in the programming step, and is at a temperature that is lower than the transition temperature of the flexible domains. The first shape, which is stable at a temperature that is higher than the transition temperature of the flexible domains, is the one shown in FIG. 4b or 5b. The second shape, which is stable at a temperature that is lower than the transition temperature of the flexible domains, is the one shown in FIG. 4a or 5a. In particular, the quick cooling that occurred in the programming step has crystallized the soft phase contained in the polymeric material, trapping elastic energy and preventing the at least one deformable portion 115, 215 from returning to the configuration shown in FIG. 4b or 5b.

Subsequently, the at least one deformable portion 115, 215 is applied for example by adhesive bonding onto the first layer 111, 211, in which the at least one opening 113, 213 has already been provided.

The trapped elastic energy is released, opening the at least one opening 113, 213, when the deformable portion 115, 215 is again at a temperature that is higher than the transition temperature of the flexible domains.

Advantageously, it is possible to differentiate the vapor permeability of the structure of the insert 10, 110 and 210, for example by increasing it at regions of the human body where perspiration is more abundant or in regions where sweat in the vapor phase accumulates the most.

The first layer 11, 111 and 211 of the above cited embodiments is preferably made of polyester or polypropylene fibers.

For example, it may be constituted by a synthetic wadding made of polyester fibers, the weight of which varies conveniently from 60 g/m² to 150 g/m².

The at least one temporarily deformable portion 15, 115 and 215 of the above cited embodiments has a thickness that is preferably but in a nonlimiting way comprised between 0.1 and 0.2 mm.

The at least one portion 15, 115 and 215 of the above cited embodiments is made of a material that undergoes a variation in at least one spatial dimension when it is subjected to temperature and/or humidity variations.

In particular, this material has the following properties:
it undergoes deformation in at least one spatial dimension if it is subjected to external forces;
it may maintain a degree of deformation in at least one spatial dimension once the external forces have been removed;
it shows a change of shape in at least one spatial dimension if subjected to temperature or humidity variations.

Such a material preferably comprises a copolymer which contains a soft phase and a rigid phase.

Considering materials that are sensitive to humidity variations, one or both of the two phases cited above contain functional groups and/or receptors to which water binds, such as for example: urea, amide, nitro, nitrile, ester, ether, hydroxyl, ethylene oxide and amine groups, or carboxylic acid salts and sulfonic acid salts, or ion groups such as sodium, zinc and potassium; and receptor sites that have an unbalanced charge distribution formed by one or more of the groups cited above.

The copolymer is preferably an elastomer, such as for example polyurethane known by the trade-name “MORTHANE PS370-200” or “PS79-200”, “PN3429”, or “PE90-100” of the company Huntsman Polyurethanes of Chicago, USA. As an alternative it is possible to use the polyurethane known by the trade-name “ESTANE” of the company BF Goodrich Performance Materials or a co-polyether amide, such as for example the one known by the trade-name “PEBAX 2533” or “3533” or “4033” of the company Elf Altochem North America, Inc., Philadelphia.

These materials contain a soft phase and a rigid phase and groups that have a high dipole moment and are sensitive to humidity.

The copolymer may contain, in addition to an elastomeric polymer, also a non-elastomeric polymer that is sensitive to humidity, such as for example polyethylene oxide, polyethylene glycol, polyvinyl alcohol, polyvinyl pyrrolidone, polyvinyl pyridine, or mixtures thereof.

Humidity absorption may reduce the rigidity and elastic modulus of the humidity-sensitive non-elastomeric polymer by at least approximately 20%, preferably 30% and even more preferably approximately 50%.

The humidity-sensitive non-elastomeric polymer is deformable in a first shape which is restored when it is subjected to humidity.

The elastomeric polymer may advantageously be permeable to water vapor in order to facilitate the absorption of humidity on the part of the humidity-sensitive non-elastomeric polymer.

The elastomeric polymer is present in the copolymer in a percentage by weight comprised between approximately 10% and approximately 95% and preferably between approximately 50% and approximately 70%, depending on the shape variation property requirements.

The at least one temporarily deformable portion 15, 115 or 215 of the embodiments of the invention described above may be constituted for example by a plurality of “MORTHANE PS370-200” polyurethane (PU) layers alternated with layers of polyethylene oxide (PEO) resin, for example the one known by the tradename “POLYOX WSR-N-3000” of the company Planet Polymer Technologies of San Diego, Calif.

The ratio between these two materials may be changed according to the contingent requirements, for example to provide transition from an open configuration of the at least one opening 13, 113 or 213 to a closed one at a certain humidity value.

Considering materials that are sensitive to temperature variations, it is possible to use for the invention for example a polyurethane-based polymer of the family known by the trade-name “DiAPLEX” of the company SMP Technologies Inc., Room 301 Ebisu First Place1-22-8, Ebisu, Shibuya-Ku, Tokyo 150-0013, Japan, the glass transition temperature of the soft phase of which, depending on the composition, varies between −40° C. and 90° C.

The polymeric material of which the at least one functional portion 15, 115 or 215 is constituted may be provided in such a manner as to have a transition temperature of the soft phase, which corresponds substantially to the glass transition temperature of the soft phase, according to the requirements of the case.

If, for example, the glass transition temperature is comprised between 32° C. and 34° C., when a temperature value comprised in this interval is reached the polymeric material passes from the second shape to the first shape, undergoing a deformation in at least one spatial dimension. This deformation acts on the at least one opening 13, 113 or 213, which passes from a substantially closed configuration to an open configuration, increasing permeability to water vapor and air of the structure of the insert 10, facilitating the evacuation of the excess heat and of the sweat in the vapor phase. If instead the internal microclimate has a temperature that is lower than said interval the at least one opening 13, 113 or 213 has a closed configuration.

The expression “closed configuration” means that opposite flaps of an opening substantially coincide or are at least mutually close, while the expression “open configuration” means that these edges are visibly spaced.

The at least one temporarily deformable portion 15, 115, 215 may be obtained starting from a polymeric material, for example in the liquid form and molded onto the first layer 11, 111, 211.

The molding of the at least one portion 15, 115, 215 on the first layer 11, 111, 211 may be performed for example by means of a screen printing process or by means of ink jet printers or by means of a molding process that comprises a step for the curing of the polymer in contact with the first layer 11, 111, 211.

As an alternative, the at least one portion 15, 115, 215 may exist for example in the form of a sheet or lamina to be glued onto the first layer 11, 111, 211, for example by means of heat-activated glue spots.

The at least one temporarily deformable portion 15, 115, 215 may be provided in such a manner as to react even or only to the presence of humidity by passing from a closed configuration to an open configuration.

Advantageously, it is also possible to obtain intermediate configurations between the open configuration and the closed configuration of the at least one opening 13, 113, 213, for example by using layers of superimposed polymers, each of which has different and clearly distinct glass transition temperatures, wherein it is possible to obtain an appropriate glass transition temperature simply by varying the degree of cross-linking of the polymer.

As an alternative it is possible to use polymeric materials that have a glass transition temperature value interval instead of a point value of the glass transition temperature. For example, it is possible to use a fluoropolymer-copolymer such as tetrafluoroethylene sulfonate, known by the trade-name “Nafion”, which has a glass transition temperature comprised between approximately 55° C. and 130° C.

The structure of the insert 10, 110, 210 has substantially a decrease of the thickness of the insulating layer in a neighborhood of the at least one opening 13, 113, 213.

In this neighborhood, the crossing of the insert 10, 110, 210 by the sweat in the vapor phase is particularly facilitated by said thickness decrease.

The at least one deformable portion 15, 115, 215 may be made of polymeric material applied to the first layer 11, 111, 211 by spraying, according to known methods which may comprise a calendering step adapted to render the thickness of said at least one deformable portion uniform.

A different production process provides for the application of the polymeric material, in sheet form, onto the first layer and fixed thereto by means of the reactivation by heating of spots of glue that are present thereon, or by means of the softening of the polymeric material of which the second layer is composed in order to allow it to grip the first layer, without the need for a calendering step. The application of the polymeric material without the calendering step is particularly advantageous since the thickness of the first layer 11, 111, 211 is substantially unchanged before and after the application of the second layer and accordingly its thermal insulation also remains unchanged.

Vapor permeability is determined according to the method described in chapter 6,6 of the ISO 20344-2004 standard.

The ISO 20344-2004 standard, in chapter 6,6 “Determination of water vapour permeability”, related to safety shoes, describes a testing method that consists in fixing a specimen of the material being tested so as to close the opening of a bottle that contains a certain quantity of solid desiccant, i.e., silica gel. The bottle is subjected to a strong air current in a conditioned atmosphere. The bottle is made to rotate so as to stir the solid desiccant and optimize its action of drying the air contained in the bottle. The bottle is weighed before and after the testing period in order to determine the mass of humidity that has passed through the material and has been absorbed by the solid desiccant.

Water vapor permeability, expressed in milligrams per square centimeter per hour (mg/cm²·h), is thus calculated on the basis of the measured mass of humidity, the opening area of the bottle and the testing time.

The terms “vapor-permeable” and “breathable” are used alternately both with the same meaning in the present description.

FIG. 7 shows an item of clothing according to the invention which comprises an insert according to the invention in a first embodiment.

The item of clothing according to the invention is designated generally by the reference numeral 300.

A detail of the item 300 is designated by the reference numeral 301 and is shown in a significant perspective view in FIG. 8.

Such detail 301 exemplifies the structure of the item of clothing 300.

The structure of the item of clothing 300 comprises an outer layer 302, an inner layer 303, which lies opposite the outer layer 302 and faces the body of the user, and between these two layers an insert 10 according to the invention.

In the example shown in FIG. 8, the insert contained between the two layers 302 and 303 is of the type that corresponds to the one described in its first embodiment.

In constructive variations of the item 300, not shown in the figures, said insert may be any one of the ones described previously.

The insert 10 has the first layer 11, which faces the outer layer 302 and the second layer 12, provided with at least one temporarily deformable portion not shown in the figures, which faces the internal layer 303 and is therefore directed toward the body of the user.

The operation of the item of clothing 300 is as follows.

Since the at least one temporarily deformable portion is directed toward the body of the user, a deformation thereof in response to a variation of the temperature and/or humidity that characterize the microclimate inside the item is immediate and localized.

It is in fact known that the human body sweats differently in different regions.

It is also known that the male body and the female body sweat in different manners.

Furthermore, it is known that a same individual sweats differently depending on the type of activity that he performs and depending on the environment in which he is located.

The term “different” refers substantially to the quantity of sweat produced.

In this first embodiment, the at least one temporarily deformable portion 15, 115, 215 is provided by means of a shape memory polymer that is sensitive to the presence of humidity.

Therefore, in the regions in which the presence of sweat is greater than a value comprised between 50 and 300 g·m⁻²·h⁻¹, more preferably comprises between 100 and 200 g·m⁻²·h⁻¹, the at least one opening 13, 113, 213 has an open configuration, whereas where the humidity is present in an amount that is below this threshold the at least one opening 13, 113, 213 has a closed configuration.

The threshold values of humidity that determine the open and closed configuration may be determined by appropriate dosing the components of the polymer.

The behavior of the polymer depends on the presence of humidity at the local level and therefore there may be, within the same item of clothing, regions in which at a given instant the at least one portion 15, 115, 215 has an open configuration and regions in which it has a closed configuration.

In this manner, in the regions of the item that corresponds to regions of the body of the user that are characterized by greater production of sweat or where an accumulation of sweat occurs, the item has a greater breathability, with respect to the regions characterized by lower sweat production.

It should be noted that by means of the invention it is possible to obtain, within a same item of clothing, regions with greater or smaller breathability, using a single insert structure, by virtue of the substantially independent behavior of each opening 13, 113, 213.

By means of this independence, adaptation to the local conditions of the body of the user occurs with a high degree of precision, which goes as far as the single opening.

It should also be noted that this adaptation is substantially immediate.

In a constructive variation, the shape memory polymer of the temporarily deformable portion 15, 115, 215 is sensitive to temperature variations.

In particular, it is possible to use a shape memory polymer with a soft phase transition temperature comprised between approximately 30° C. and approximately 36° C.

Preferably, the shape memory polymer has a soft phase transition temperature comprised between approximately 31° C. and approximately 35° C.

More preferably, the shape memory polymer has a soft phase transition temperature comprised between approximately 32° C. and approximately 34° C.

Experimental tests in fact demonstrate show that the microclimate within a coat or jacket reaches a steady state condition, in conditions of moderate physical activity, after approximately 20 minutes.

The highest temperature values are detected at the armpit, at the shoulders and at the center of the back, and appear substantially consistent with the values related to humidity. The feeling of discomfort is perceived by the user in the presence of a temperature of approximately 34° C.

Therefore, the choice of an SMP polymer with such a soft phase transition temperature allows to open the at least one opening 13, 113, 213 to facilitate the evacuation of the sweat in the vapor phase indeed when the feeling of discomfort occurs.

In some variations, not shown in the figures, it is possible, both if the shape memory polymer is sensitive to temperature variations and if it is sensitive to humidity variations, to provide a mapped item of clothing.

The term “mapped” is understood to mean that the item has an insert 10, 110, 210 that is differentiated by regions that correspond to given regions of the human body. In order to obtain a differentiation of the regions of the insert it is possible to vary the following characteristics individually or in combination:
number of cuts 14;
density of the cuts 14, i.e., number of cuts per unit surface;
number of openings 13, 113, 213;
density of openings 13, 113, 213, i.e., number of openings 13, 113, 213 per unit surface;
dimensions and/or depth of the openings 13, 113, 213.

These regions are defined appropriately on the basis of a mapping of sweating of the human body and/or of the temperature that characterizes the microclimate inside an item as described previously.

For example, the region at the armpit may have a greater density of openings than the forearm region, or a larger opening size or both of these characteristics.

FIG. 9 is a top view of an item of clothing 400 according to the invention, disassembled into its components and seen from the inside.

The item 400 comprises two front parts, respectively a left part 401a and a right part 401b, which face the front portion of the body of the user and, opposites these two, a rear part 403, which faces the back of the user.

The right and left sleeves are designated respectively by the reference numerals 402a and 402b.

These parts have a first region and a second region with a differentiated insert, which are designated respectively by 404 and 405.

The regions 404 and 405 have a different sensitivity to temperature and/or humidity variations.

The expression “different sensitivity” means that one region has a lower sensitivity to temperature and/or humidity variations with respect to the other, by virtue of a difference of characteristics of the at least one temporarily deformable portion 15, 115, 215 and/or of the first layer 11 as described above.

By way of non-limiting example, in the embodiment shown in FIG. 9, the region 404 has an insert structure 10, 110, 210 which comprises a first layer 11, 111, 211 provided with openings 13, 113, 213, not shown in the figures, with a length comprised between approximately 5 and 15 mm, or preferably between 8 and 12 mm. Preferably, the first layer 11, 111, 211 has a density of openings comprised between approximately 500 and approximately 4000 openings/m², more preferably comprised between approximately 1000 and approximately 2000 openings/m². The second region 405 instead has a structure that is different from the structure of the insert 10, 110 for 210 described previously and is constituted for example by wadding of a known type.

The first region 404 is located predominantly at the upper portion 404d of the chest and shoulders, at the upper portion 404s of the back and shoulders, and at the left armpit 404a and right armpit 404b.

The first region 404 is furthermore provided with a portion 404t which is shaped like an reversed T, the rod of which joins the portion 404s, arranged at the upper portion of the back and shoulders, and the cut of which is extended predominantly at right angles to the rod at the height of the kidneys.

This shape allows an optimization of the temperature regulation of the item 400 in view of the “mapping” of the perspiration of the human body.

It should be noted that the use of the structure of the insert 10, 110, 210 in a manner that is limited to some regions, instead of the entire item of clothing, allows to contain production costs.

FIG. 10 shows footwear 500 according to the invention which comprises an insert according to the invention.

A detail of footwear 500 is designated by the reference numeral 501 and is shown in a significant perspective view in FIG. 11.

This detail 501 exemplifies the structure of footwear 500.

The structure of footwear 500 comprises an external layer 502, an internal layer 503, which is opposite with respect to the external layer 502 and faces the foot of the user, and between these two layers, at least along part of the extension of the upper, an insert 10 according to the invention.

In the example shown in FIG. 8, the insert contained between the two layers 502 and 503 is of the type that corresponds to the one described in its first embodiment.

In constructive variations of footwear 500, not shown in the figures, this insert may be any one of the ones described previously.

The external layer 502 is preferably constituted by a fabric and/or leather which are vapor-permeable, and are also of a known type.

The internal layer 503 is preferably constituted by a vapor-permeable fabric and/or leather of a known type.

The insert 10 has the first layer 11, which faces the external layer 502 and the second layer 12, provided with at least one temporarily deformable portion not shown in the figures, which faces the internal layer 503 and is therefore directed toward the foot of the user.

The at least one temporarily deformable portion 15, 115, 215, not shown in FIGS. 10 and 11, comprises a shape memory polymer that is sensitive to humidity variation.

Therefore, where the humidity is greater than a value comprised between 50 and 300 g·m⁻²·h⁻¹, more preferably comprised between 100 and 200 g·m⁻²·h⁻¹, the at least one opening 13, 113, 213 has an open configuration, whereas where humidity is present to an extent that is lower than this threshold the at least one opening 13, 113, 213 has a closed configuration.

As an alternative it is possible to use a shape memory polymer that is sensitive to temperature variations and has a soft phase transition temperature value comprised between approximately 30° C. and approximately 36° C., beyond which the opening of the at least one opening 13, 113, 213 occurs in order to facilitate the evacuation of the sweat in the vapor phase indeed when the feeling of discomfort occurs.

The use of an SMP is advantageous since it allows a precise adjustment of the insert 10, 110, 210, since the shape variation is sudden and delimited to the neighborhood of a temperature or humidity value.

However, in constructive variations of the invention it is possible to use polymers, not necessarily SMPs, which react to temperature and/or humidity variations, such as for example hydrophilic polymers.

The reaction of these polymers generates a swelling which causes a tension which acts on the at least one opening 13, 113, 213, producing an open or closed configuration thereof. The use of these polymers is particularly suitable if the at least one deformable portion 15, 115, 215 is applied by spraying, molding or screen printing.

The at least one deformable portion 15, 115, 215 may be constituted, in a manner alternative to SMPs, for example by two layers of materials that have thermal expansion coefficients that differ by more than approximately 1.8·10⁻⁵/° C.

For example, it is possible to use two layers respectively made of polyethylene, with a thermal expansion coefficient of approximately 14.4·10⁻⁵/° C., and polyvinyl chloride (PVC), with a thermal expansion coefficient of approximately 5.4·10⁻⁵/° C. and having a thickness preferably comprised between 0.025 and 0.25 mm.

In practice it has been found that the invention achieves the intended aim and objects, providing a vapor-permeable insert for an item of clothing and footwear, characterized in that it comprises a first layer which has at least one blind opening and a second layer which has at least one temporarily deformable portion which comprises a material that is sensitive to humidity and/or temperature variations.

The invention thus conceived is susceptible of numerous modifications and variations, all of which are within the scope of the inventive concept; all the details may furthermore be replaced with other technically equivalent elements.

In practice, the materials used, so long as they are compatible with the specific use, as well as the contingent shapes and dimensions, may be any according to the requirements and the state of the art.

The disclosures in Italian Patent Application no. 102018000002423, from which this application claims priority, are incorporated herein by reference.

Where technical features mentioned in any claim are followed by reference signs, those reference signs have been included for the sole purpose of increasing the intelligibility of the claims and accordingly such reference signs do not have any limiting effect on the interpretation of each element identified by way of example by such reference signs.

1. A vapor-permeable insert for an item of clothing and footwear, comprising:
at least one first layer provided with at least one blind opening; and
at least one second layer, which has at least one temporarily deformable portion, which includes a material that is sensitive to humidity and/or temperature variations.

2. The vapor-permeable insert according to claim 1, wherein said second layer is substantially coupled to said first layer at least at each said deformable portion, in a neighborhood comprising said at least one opening.

3. The vapor-permeable insert according to claim 1, wherein said material sensitive to humidity and/or temperature variations is of the polymeric type with shape memory.

4. The vapor-permeable insert according to claim 1, wherein said polymeric material with shape memory has a soft phase transition temperature comprised between approximately 30° C. and approximately 36° C.

5. The vapor-permeable insert according to claim 1, wherein said polymeric material with shape memory has a humidity threshold value, for transition from a second shape to a first shape, comprised between approximately 50 and approximately 300 g·m-2·h-1.

6. The vapor-permeable insert according to claim 1, wherein said second layer has, inside said portion, which is temporarily deformable, at least one through cut and in that said at least one cut is at least partially superimposed on said at least one opening.

7. The vapor-permeable insert according to claim 1, wherein said at least one cut has a geometric shape like a cross and/or a letter C and/or a letter L and/or a letter T and/or a crescent and/or combinations thereof.

8. The vapor-permeable insert according to claim 1, wherein said at least one opening substantially has the same geometric shape as the at least one corresponding cut.

9. The vapor-permeable insert according to claim 1, wherein said at least one opening has a depth comprised between 0.1 and 0.8 mm.

10. An item of clothing, comprising an insert according to claim 1.

11. The item of clothing according to claim 10, further comprising:
an external layer, an internal layer, which lies opposite said external layer and faces the body of the user, between said two layers there being said insert, which has said first layer which faces said external layer and said second layer which faces said internal layer.

12. The item of clothing according to claim 1, further comprising:
a first region and a second region which have different sensitivities to temperature and/or humidity variations.

13. The item of clothing according to claim 1, wherein said first region is arranged predominantly at the upper portion of the chest and shoulders, at the upper portion of the back and shoulders, and at the left armpit and right armpit, and has a portion shaped like a reversed T, said reversed T having a rod which is connected to the upper portion of the back and shoulders, and a cut which is extended predominantly in a direction that is perpendicular to said rod at the level of the kidneys.

14. Footwear comprising, at least for part of the extension of the upper, an insert according to claim 1.

15. The footwear according to claim 14, further comprising:
an external layer, an internal layer, which lies opposite said external layer and faces the foot of the user, between said two layers there being said insert, which is provided with said first layer which faces said external layer and said second layer, which faces said internal layer.
